(19) United States
(12) Patent Application Publication
(10) Pub. No.: US 2007/0187163 A1
(43) Pub. Date: Aug. 16, 2007

(54) Noise reducing side shields

(75) Inventors: Kerry M. Cone, Bellevue, IA (US); Jay R. Stienstra, Dubuque, IA (US); Rex R. Graham, Bellevue, IA (US)

Correspondence Address: BAKER & DANIELS LLP, 300 NORTH MERIDIAN STREET, SUITE 2700, INDIANAPOLIS, IN, 46204, US

(73) Assignee: Deere and Company

(21) Appl. No.: 11/397,650

(22) Filed: Apr. 4, 2006

Related U.S. Application Data
(63) Continuation-in-part of application No. 11/351,820, filed on Feb. 10, 2006, now abandoned.

(51) Int. Cl. B62D 25/10

(52) U.S. Cl. 180/69.2

(57) ABSTRACT

Side panels for internal combustion engine housings lacking rectilinear access to housing suppress engine noise.

Priority is claimed from U.S. patent application Ser. No. 11/351,820.

### BACKGROUND

The instant invention relates to noise suppression of industrial/agricultural an enclosure of an internal combustion engine that permits ventilation, yet suppresses noise generated by the internal combustion engine.

Noise suppression has been an objective of several advances in the art focused on the radiator of water-cooled internal-combustion engines. U.S. Pat. No. 4,483,412 discloses such an engine enclosure provided with non-rectilinear air passages to permit air flow, but block noise vibration which travels by a line of sight. Coating the surfaces of such passages with a sound damping cellular or expanded foam is disclosed.

Engine fan noise is the focus of U.S. Pat. No. 4,260,037 which discloses a structure comprising resonator chambers with sound absorbent therein.

Further focus on the noise generated by the axial fan providing cooling air to a radiator is found in U.S. Pat. No. 4,212,369. A series of parabolic shaped structures aided by sound absorbent admit cooling air, yet block the exit of sound in the direction opposite the flow of cooling air.

U.S. Pat. No. 4,289,096 is focused on noise suppression of noise from the fan providing air to a radiator of a water-cooled internal-combustion engine. The reference provides a structure mounted opposite the radiator comprising in part acoustic energy absorbing material.

U.S. Pat. No. 5,332,872 discloses sound absorbing baffles in the air inlet of a stationary cooling fan. The baffles are arranged to block rectilinear sound passage from the fan to beyond the baffle structure. A similar objective may be found in U.S. Pat. No. 4,122,908 for a vehicle where noise absorbing material is combined with porous panels disposed angularly to the direction of air flow to a vehicle radiator.

### BRIEF DESCRIPTION OF THE DRAWINGS

FIG. 1 is a representation of a crawler-type heavy-equipment vehicle for which the instant invention may be suitable.

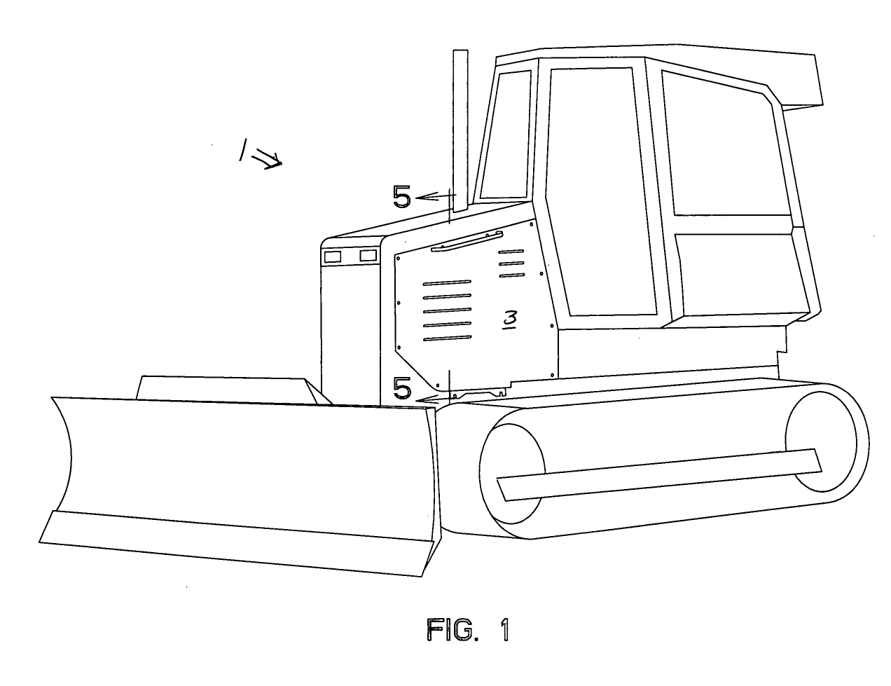

FIG. 2 is an exploded view of a panel for covering the internal-combustions engine area of a heavy-equipment vehicle.

FIG. 3 is a view of a panel for covering the internal combustion engine area of a heavy-equipment vehicle.

FIG. 4 is a section view of the panel of FIG. 3

FIG. 5 is a section view of a panel for covering the internal combustion area of a heavy-equipment vehicle.

### DETAILED DESCRIPTION

The present invention is directed to noise suppression of internal-combustion engine focused on the engine housing or enclosure. The invention is described generally in terms of water-cooled heavy equipment of construction/agricultural/civil works machines, but the principles here disclosed will find application beyond these applications to internal combustion engine noise generally.

Heavy equipment such as a crawler/dozer 1 generally has its internal combustion engine oriented with the engine crankshaft parallel with the direction of radiator-air flow. Also parallel to the engine orientation are removable engine-cover panels 3 permitting access to the engine for service and repair. The panels in the art are comprised of perforated panels, or louvered panels, historically of steel. The planar orientation of such panes is generally vertical as the panels form covers on the sides of the engine compartment.

Engine noise, including that originating from the fan moving cooling air through the radiator, is added to noise from internal engine components such as the impact of the combustion explosion on the piston and connected components: connecting rods, and crankshaft driven by the force of explosion against the connected component. Further, engine accessories, such as belt driven components such as electrical alternators or generators, air conditioners, cumulatively add to the noise of the cooling fan.

While attention to engine originating noise has been given to the noise generated by the co-axial cooling fans, little attention has been given to engine noise emanating orthogonal to the engine orientation. In the case of the crawler/dozer, the portion of the machine beneath the engine is generally enclosed to prevent damage to the engine by debris encountered in the normal operation of such machines. The engine housings of other heavy machines such as wheel loaders, motor graders, are often open beneath the engine housing thus affording an exit for cooling air. The side panels of such machines, being open beneath the engine, need not be perforated or louvered. In the case of heavy machines having engine housings closed beneath the engine, the cooling air entering the radiator is forced to exit orthogonal to the engine orientation through the side panels. Accordingly, such machines generate a higher level of ambient noise of engine origin.

The instant invention reduces the noise originating from conventional perforated or louvered engine side panels.

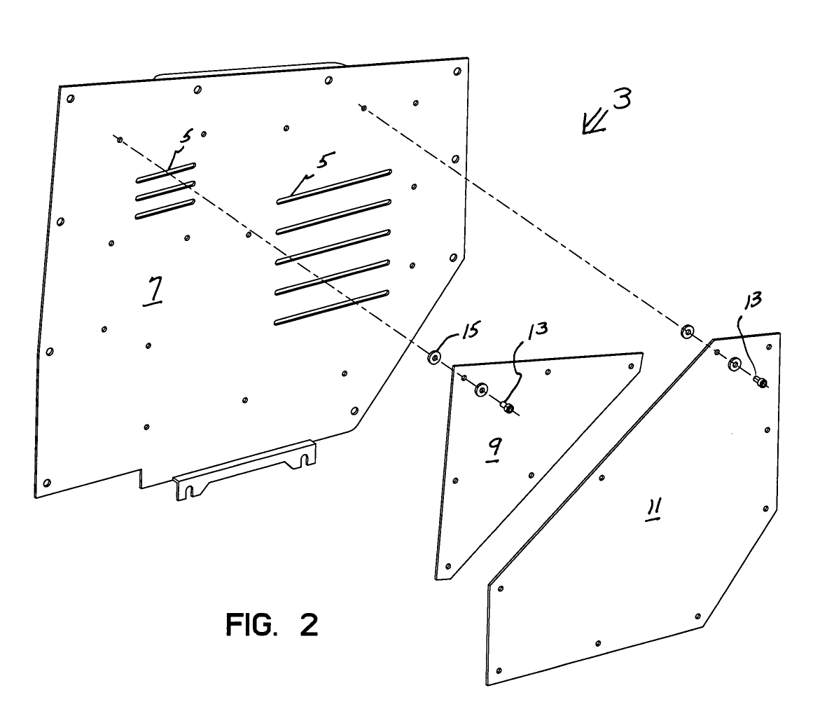

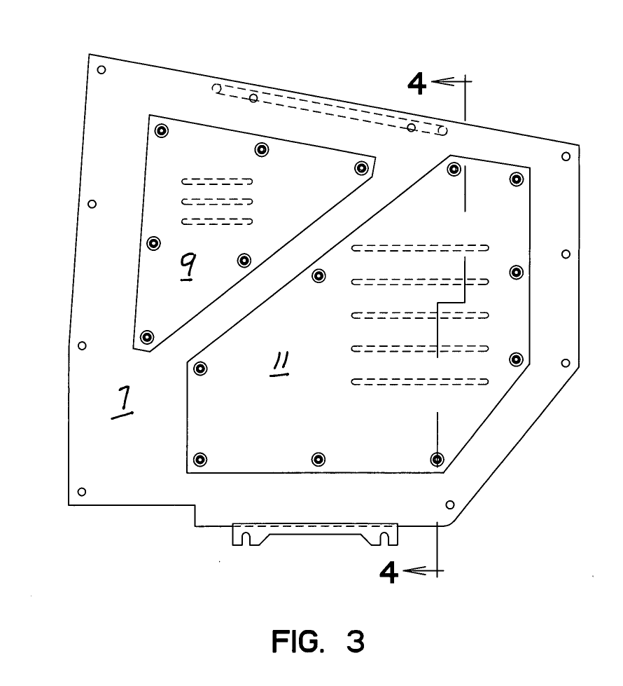

FIGS. 2, 3, and 4 show openings 5 for air flow on a major panel 7 not unlike engine coverings for heavy-equipment vehicles of the present art. The openings of the present art are frequently in the form of louvers oriented to reduce access to the engine area of rain and snow.

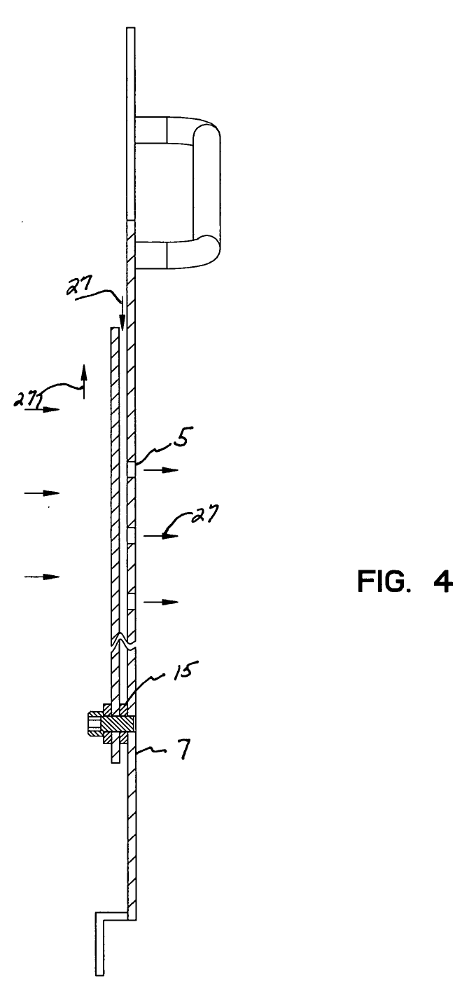

Secondary panels 9, 11 attach to the major panel 7 by bolts 13. In the embodiment illustrated, the secondary panels are not provided with openings for air flow. FIGS. 2 and 4 show the secondary panels as spaced apart from the major panel by spacers 15 providing access for air communication around secondary panels 9, and 11 and through openings 5 of the major panel 7. However, air communication is limited so as to obstruct rectilinear air flow, and thereby block direct sound/noise escape from the engine compartment. Arrows 27 suggest a path for air flow around secondary panels 9, 11 through openings 5.

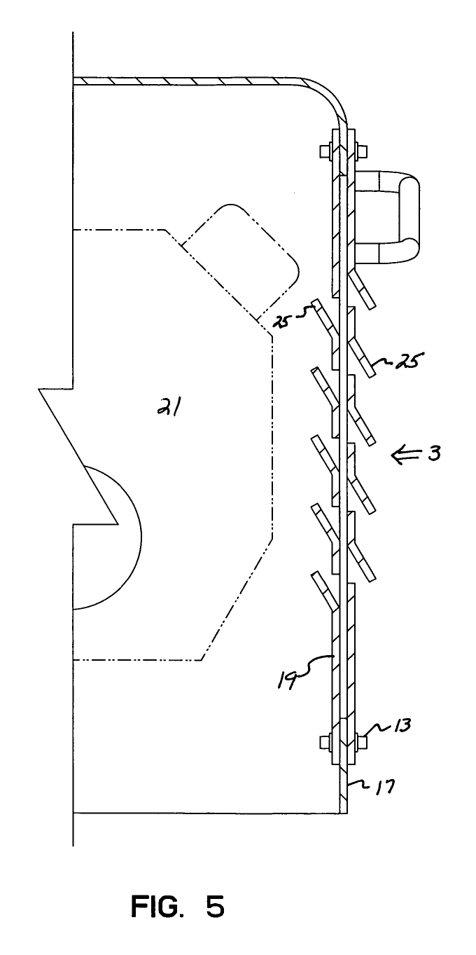

FIG. 5 illustrates a further embodiment where in the major panel 7 is cut-out. The cut-out openings 5 of major panel is covered by an inboard louver panel 19 on the side of the major panel nearer the engine 21, and an outboard louver panel 23. The louvers 25 are oriented to facilitate air communication through the engine-cover panel 3, while obstructing rectilinear flow, and thereby blocking direct sound/noise escape from the engine compartment.

The side panels of the instant invention are formed of at least two layers with supporting internal structure provided by one of the panel layers, or separately. The at least two layers include an outer layer and an inner layer nearer to the engine. Openings 5 permit passage of cooling air to enter or exit the engine housing. The openings of the side panel layers are oriented such that the openings are not rectilinear, i.e., there is no line-of-sight into the engine compartment to the outer layer of the engine panel.

Additional noise reduction may be accomplished by the addition of acoustic energy absorbing material to one or more of the panel layers, using energy absorbing material as the inner or outer panel layer, or affixing an energy absorbing material to a panel layer.

By eliminating line of sight access from inside the engine housing, the engine noise experienced by the observer may be reduced by a factor of ten.

The noise-reducing engine panel claimed herein may be provided as an integral part of a vehicle, or as an aftermarket or manufacturer's option.

1. A noise-reducing engine panel for an engine housing comprising a generally vertically oriented panel having openings therein oriented such that when installed on an engine housing generally parallel to the engine crankshaft there is no line of sight access to the engine housing through the engine panel openings.

2. A heavy machine incorporating the noise-reducing panel of claim 1.

3. The panel of claim 1 further comprising an acoustic-energy absorbing material.

4. A heavy machine incorporating the noise-reducing panel of claim 3.

5. The panel of claim 3 wherein the absorbing material is affixed to a panel layer.

6. The panel of claim 3 wherein the absorbing material is separate from a panel layer.

7. The panel of claim 1 wherein the engine panel comprises three panel layers.

8. The panel of claim 7 wherein at least one panel layer comprises acoustic-energy absorbing material.

9. A heavy machine incorporating the noise-reducing panel of claim 5.

10. A heavy machine incorporating the noise-reducing panel of claim 6.

11. A heavy machine incorporating the noise-reducing panel of claim 7.

12. A heavy machine incorporating the noise-reducing panel of claim 8.
